(19) United States
(12) Patent Application Publication
(10) Pub. No.: US 2005/0076080 A1
(43) Pub. Date: Apr. 7, 2005

(54) Customization of error handling based on type of user agent

(76) Inventor: Tejkumar Arora, Sunnyvale, CA (US)

Correspondence Address: GLENN PATENT GROUP, 3475 EDISON WAY, SUITE L, MENLO PARK, CA, 94025, US

(21) Appl. No.: 10/478,786

(22) PCT Filed: May 29, 2001
(86) PCT No.: PCT/US01/17380

(51) Int. Cl. G06F 15/16

(52) U.S. Cl. 709/203

(57) ABSTRACT

A World Wide Web (web) server built-in service access function (SAF) is overridden with a service having intelligence about the type of user-agent to which an error page is being served. In this way, error messages are served to a client in a platform appropriate manner.

### BACKGROUND OF THE INVENTION

1. Technical Field

The invention relates to error handling. More particularly, the invention relates to a World Wide Web (Web) site customizing error handling for a variety of end user devices.

2. Description of the Prior Art

Currently, Web servers can customize error messages for different error codes resulting on resident Web sites. That is, Web servers can serve customized error pages on specific errors. However, such Web servers serve only HTML MIME type error messages because only HTML MIME type messages are supported. Thus, WAP phones, PDA's, and other such devices that do not understand HTML MIME type are not able to display their corresponding custom error pages having appropriately customized content, and may, instead, display unpredictable behavior. Such unpredictable behavior can be detrimental to an organization or individual with an interest in a Web site accessed by such devices.

W. Doviak, D. L. Whitmore, and F. Houvig, Apparatus and Method for Intelligent Routing of Data Between a Remote Device and a Host System, U.S. Pat. No. 6,198,920 (Mar. 6, 2001) discloses an apparatus and method for transparent communication between a remote or mobile device and a fixed communication host network. The apparatus and method may include a remote network controller that logically resides between the host network and the existing infrastructure(s) that are used to provide communications network contact with one or more remote devices. The remote network controller is connected to the host communication network as a protocol-appropriate communications controller so that remote devices are indistinguishable to the host network from the locally-attached devices. Each remote device may be provided with an asynchronous serial data interface to communicate with a mobile data controller. The mobile data controller, in combination with the remote network controller, provides end-to-end data communication such that incompatible protocols are transparent to the remote device and host communication network. A router may be provided which selects a communications network in accordance with user configured parameters. The router communicates over a plurality of incompatible networks and is capable of using a variety of different protocols. Switching between the plurality of incompatible networks is transparent to the remote device and host communication network.

Doviak et al teach a complicated communications system that includes at least the use of special routers and interfaces.

T. F. LaPorta. K. K. Sabnani, and T. Y. C. Woo, Two-way Wireless Messaging System Having User Agent, U.S. Pat. No. 5,970,122 (Oct. 19,1999) discloses a two-way wireless messaging system that includes a messaging network having at least one user agent corresponding to a subscriber of a two-way wireless messaging service. The subscriber receives messages from the messaging network along a first communication channel. The user agent includes a plurality of messages stored therein wherein a predetermined message is stored in the user agent and forwarded to a desired destination in response to an originating message code that is received from a two-way messaging device of the subscriber along a second communication return channel. The originating message code can be expanded by the user agent. The messages stored by the user agent can be modified so that different messages can be forwarded to the predetermined destination. The user agent also maintains location information of the two-way messaging device of the subscriber.

LaPorta et al teaches communication on a two-way wireless messaging system, and does not teach a simple and elegant way for a Web server to handle errors experienced by a variety of linked devices.

T. F. LaPorta. K. K. Sabnani, and T. Y. C. Woo, Two-way Wireless Messaging System, U.S. Pat. No. 5,918,158 (Jun. 29,1999) discloses a way to improve upon a two-way messaging system allowing messages to be originated from a wireless messaging device and replies to be dynamically customizable by the recipients. LaPorta et al teach a hybrid system between traditional paging and electronic mail, improving on traditional paging and messaging services as well as any proposed two-way messaging services by adding direct message origination and reply capability with various capabilities for some message modification and response. However, LaPorta et al does not teach customizing error handling by Web servers for a variety of end user devices.

It would be advantageous to provide a method and apparatus that allows sending a correct error page to a linked device and that is both simple and elegant in design and implementation.

It would be advantageous to provide a method and apparatus that allow Web serves to manage error handling for a variety of different types of linked end users, such as personal computers, hand-held devices, and the like.

### SUMMARY OF THE INVENTION

A method and apparatus is provided that enables a Web server to customize error messages for a variety of linked communicating devices, such as, for example, cell phones and personal digital assistants (PDAs).

A Web server built-in service access function (SAF) is overridden with a service having intelligence about the type of user-agent to which an error page is being served. In this way, error messages are served to a client in a platform appropriate manner.

### BRIEF DESCRIPTION OF THE DRAWINGS

FIG. 1 is a schematic diagram showing error handling by a Web server for a personal computer according to the prior art;

FIG. 2 is a schematic diagram showing error handling by a Web server for a personal computer or a different device according to the prior art;

FIG. 3 is a schematic diagram showing error handling by a Web server for a personal computer or a different device according to the invention;

FIG. 4 is a flow diagram of a method according to the prior art; and

FIG. 5 is a flow diagram of a method according to the invention.

### DETAILED DESCRIPTION OF THE INVENTION

A method and apparatus is provided that enables a Web server to customize error messages for a variety of linked communicating devices, such as, for example, cell phones and personal digital assistants (PDAs).

A Web server built-in service access function (SAF) is overridden with a service having intelligence about the type of user-agent to which an error page is being served. In this way, error messages are served to a client in a platform appropriate manner.

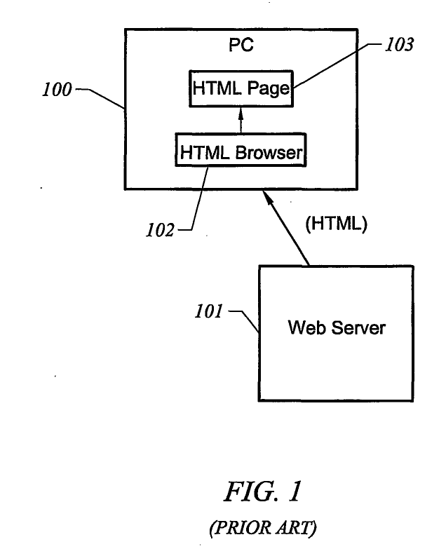

According to the prior art described with reference to FIG. 1, a personal computer (PC) client 100 accesses a Web server 101 serving content. Typically the end user accesses the Web server 101 from the PC 100 using an HTML compatible browser 102. Examples of browsers are Netscape® Communicator 4.75, Copyright © 1994-2000 Netscape Communications Corporation, 466 Ellis Street, Mountain View, Calif. 94043-4042, and Microsoft Internet Explorer 5.5, Copyright © 2000 Microsoft Corporation, One Microsoft Way, Redmond, Wash. The browser 102 then renders the content sent in HTML format as an HTML page 103 for an end user to view on the client PC 100.

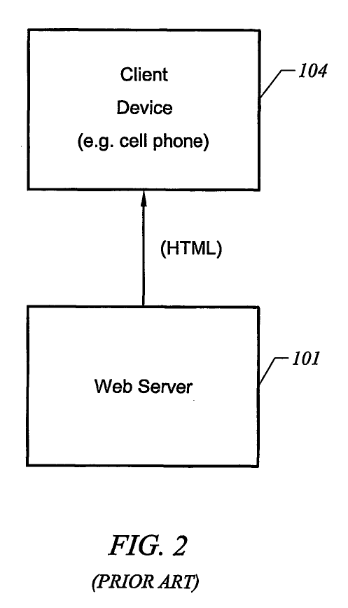

However, when the HTML content is served to a device other than a PC 100, such as, for example, a cell phone, the device may not understand HTML. FIG. 2 is a schematic diagram showing error handling by a Web server according to the prior art. Such device 104 understands a different language and renders a different format. It doesn't render HTML. It is has been observed that when HTML is sent to a cell phone, the end user experiences unpredictable behavior by the cell phone. Sometimes the cell phone session crashes.

It should be appreciated that content types are also known as MIME types, and are used interchangeably herein. Some examples of MIME types other than HTML are wml and hdml, which is an adaptation of html for a small device.

In the preferred embodiment of the invention, the Web server 101 serves many kinds of end user devices, such as, for example PCs, hand-held devices, and the like in the appropriate MIME type.

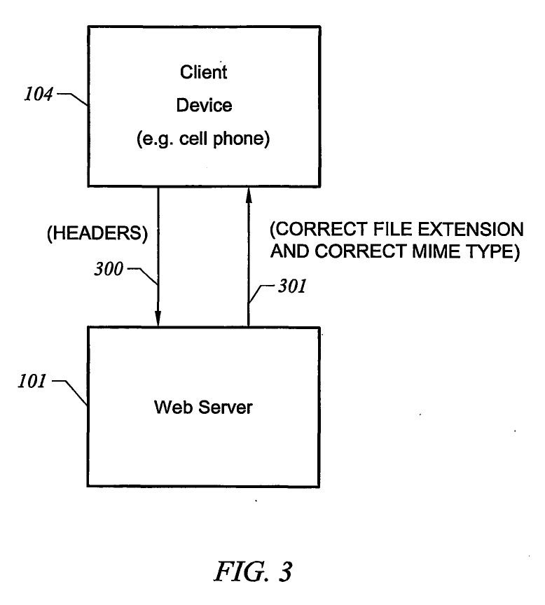

The preferred embodiment of the invention is described with reference to FIG. 3. The Web server 101 requests information about the device 104, and receives two headers 300. The first header contains information about the type of device encountering the error at hand and its running software, such as the Netscape Navigator 4.1 browser. The second header contains information about the content type, or MIME type in which format the Web server sends the error page to the device 301.

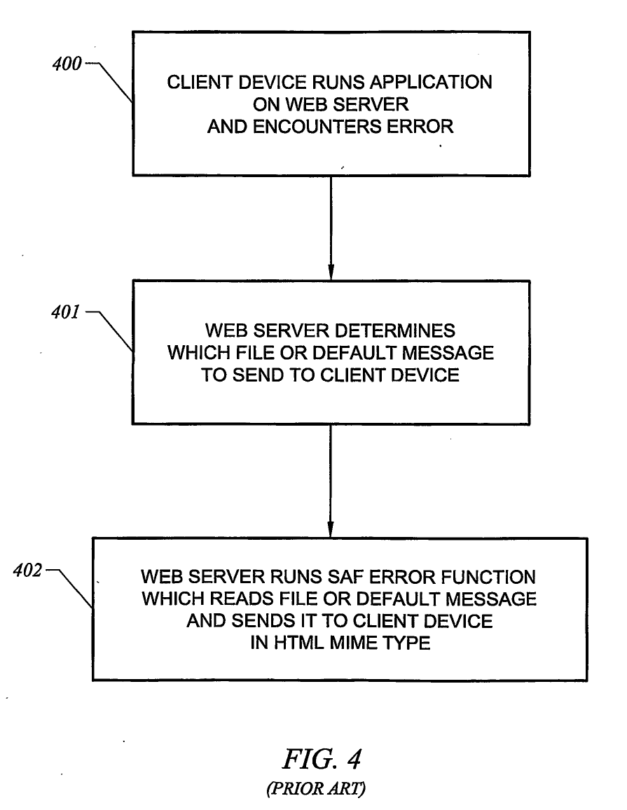

An example of a method for error handling according to the prior art is described with reference to FIG. 4. Typically, a Web server has a configuration file which contains a map of types of errors to corresponding error files to return to the client. Therefore, when the client encounters an error (400) in the application, the Web server can look up a map and determine the corresponding error file to return to the client (401). For example, if the error code is 401, then the Web server would return an error file for 401 back to the client. The Web server runs a service access function (SAF) that reads the error file and sends the content to the client in HTML MIME type (402). In cases when there is no corresponding error file, the Web server typically returns a default error file.

It should be noted that, unfortunately, the Web server blindly reads the error file and sends it to the client in HTML MIME type, regardless of the type of device.

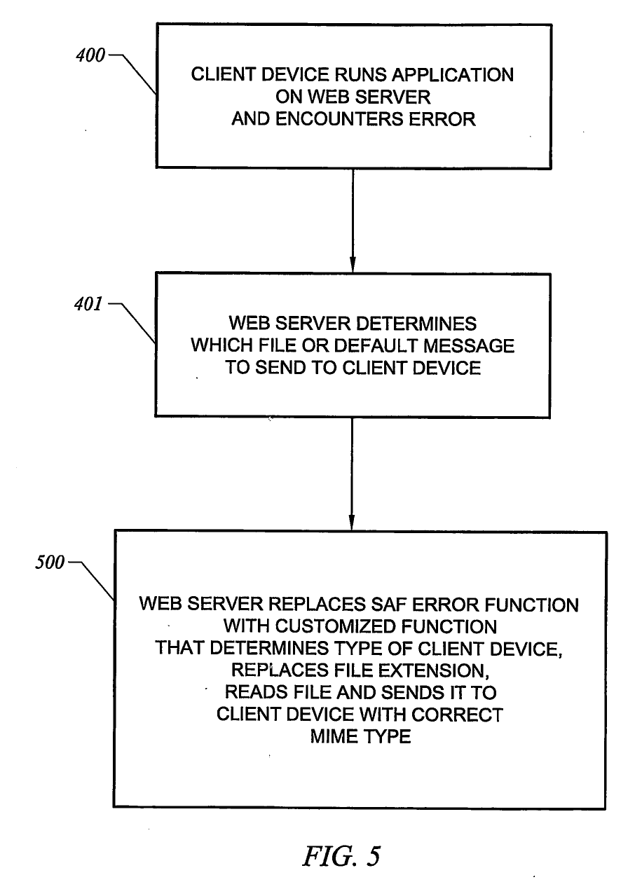

The preferred embodiment of the invention overrides the SAF when an error occurs. The preferred embodiment of the invention can be described with reference to FIG. 5. Upon determining which file or default message to send to the client (401), the Web server replaces the SAF with its own intelligence, using built-in functionality (500). The replaced SAF determines the type of device encountering the error, replaces the file extension with an appropriate file extension for the client device, reads the file, and sends it to the client with the correct MIME type (500).

For example, according to the preferred embodiment of the invention, if the error filename is foo.html and the client device is a wml-type, the replacement SAF replaces the extension so that the name of the file sent is foo.wml. Then, the replacement SAF reads the file and sends it with the wml MIME type.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method for a World Wide Web (Web) server to process an error encountered by a client, said method comprising:
determining an appropriate error file to send to said client, said error file associated with said error;
using a replaced SAF, said replaced SAF:
determining type of client;
adjusting said error file by incorporating said client type; and
sending said adjusted error file to said client.

2. The method of claim 1, said determining type of client, further comprising:
requesting and reading corresponding headers.

3. The method of claim 1, said determining type of client, further comprising:
determining device and running software of said client; and
determining content type of said client.

4. The method of claim 3, further comprising:
said adjusting error file replacing a default error file extension with an appropriate error file extension, said appropriate file extension corresponding to said running software of said client; and
said sending said adjusted error file with said determined content type.

5. The method of claim 1, wherein said client is any of, but not limited to:
a personal computer, a cell phone, a personal digital assistant (PDA), and the like.

6. The method of claim 3, wherein said content type is any of, but not limited to:
Html, wml, and hdml.

7. An apparatus for a World Wide Web (Web) server to process an error encountered by a client, said apparatus comprising:
means for determining an appropriate error file to send to said client, said error file associated with said error;
means for using a replaced SAF, said replaced SAF providing:
means for determining type of client;
means for adjusting said error file by incorporating said client type; and
means for sending said adjusted error file to said client.

8. The apparatus of claim 7, said means for determining type of client, further comprising:
means for requesting and reading corresponding headers.

9. The apparatus of claim 7, said means for determining type of client, further comprising:
means for determining device and running software of said client; and
means for determining content type of said client.

10. The apparatus of claim 9, further comprising:
said means for adjusting error file providing means for replacing a default error file extension with an appropriate error file extension, said appropriate file extension corresponding to said running software of said client; and
said means for sending said adjusted error file with said determined content type.

11. The apparatus of claim 7, wherein said client is any of, but not limited to:
a personal computer, a cell phone, a personal digital assistant (PDA), and the like.

12. The apparatus of claim 7, wherein said content type is any of, but not limited to:
HTML, wml, and hdml.
